(19) United States
(12) Patent Application Publication
(10) Pub. No.: US 2004/0115318 A1
(43) Pub. Date: Jun. 17, 2004

(54) Food packaging laminates

(76) Inventors: Annegret Janssen, Luneberg (DE); Wolfgang Zenker, Adendorf (DE)

Correspondence Address: H B Fuller Company, Patent Department, 1200 Willow Lake Boulevard, P O Box 64683, St. Paul, MN, 55164-0683, US

(21) Appl. No.: 10/433,027

(22) PCT Filed: Nov. 7, 2001
(86) PCT No.: PCT/EP01/12879

(51) Int. Cl. A23B 4/00

(52) U.S. Cl. 426/124

(57) ABSTRACT

The invention relates to a flexible packaging. Specifically, this invention relates to a laminate, the use of the laminate in the packaging of food, drinks, medicine and toys, and a corresponding package. The laminates can be a film-to-film and film-to-foil laminates, suitable for typical food packaging uses, using hot melt laminating adhesives. Such laminates are substantially free from volatile contaminates, especially migratable isocyanates and aromatic amines.

### BACKGROUND OF THE INVENTION

The invention relates to a flexible packaging. Specifically, this invention relates to a laminate, the use of the laminate in the packaging of food, drinks, medicine and toys, methods of producing such laminates, methods of packaging articles and a corresponding package.

It is well known to package food in wraps, bags, pouches etc. made of laminates. Preferred materials for food packaging often consist of a first substrate, such as a film, which is generally thin and transparent, but can be printable, and a second substrate which can be another, (often thicker) film, a metal foil, a metalized film etc.

Whereas in the past, such film-to-film and film-to-foil laminations were often produced using volatile organic solvent-based laminating adhesives, environmental and regulatory restrictions have in the more recent past caused the industry to use waterborne adhesives, especially polyurethane dispersions and acrylic emulsions.

Examples of polyurethane dispersions are disclosed in U.S. Pat. Nos. 5,494,960, 5,532,058, 5,861,410, 5,907,012 and 5,834,554. U.S. Pat. No. 5,907,012 are specially suitable for indirect food contact and U.S. Pat. No. 5,834,554 for direct food contact packaging.

Recently, the laminating industry has begun to investigate into solvent-free two-component reactive adhesives. Although some of these are applied at elevated temperatures, these are not hot melt adhesives.

Also the food industry has begun to use similar laminates, as food packaging materials. Such laminates are produces using reactive, generally polyurethane-based laminating adhesives.

However, film-to-film and film-to-foil laminates using solvent-free reactive laminating adhesives, even including two-component polyurethane laminating adhesives, may lead to problems specifically in food. In some cases, solvent-free reactive laminating adhesives may retain relatively high levels of monomer, unless they are very carefully cured. Such careful curing requires time and energy expenditure. Whereas in many applications of laminated materials, such monomer contamination does not present a problem, this is not true in the food industry, since the monomers may migrate into the food, which is not acceptable.

specifically, the use of reactive polyurethane adhesives has in some cases been found to lead to contamination of the packaged food with unreacted isocyanates and carcinogenic aromatic amines (probably formed by reaction of adhesive components with moisture from the food).

Thus, food packaging materials may release volatile and/or migratable contaminations which result from the adhesives used in manufacturing such materials.

This problem is, as far as the food industry is concerned, acerbated by the need for just-in-time production and delivery, such restraints actually promoting the use of not fully cured laminates.

Food as mentioned herein includes any item, whether edible or not, that are intended to be brought into contact with the body of a mammal, especially put into people's mouth, such as food items, drinks, medicine and baby toys. Mammals in this context include humans. Contact with the body means the possibility of undesired contamination of the body by volatiles and/or migratables as defined above.

### SUMMARY OF THE INVENTION

The present inventors have invented a laminate that overcomes these problems in the prior art.

The invention specifically provides a laminate for use in food packing. The laminate can be based on a laminate of a (conventional) film material and a second (conventional) substrate, using a hot melt (solvent-free) laminating adhesive, which is substantially free from volatile and/or migratable contaminants, especially monomeric or oligomeric isocyanates and aromatic amines.

Another aspect of the present invention is to identify the use of such flexible laminating materials in food packaging and a corresponding method of packaging food items. The laminate can be a film-to-film and film-to-foil laminate, suitable for typical food packaging uses, using solvent-free non-reactive hot melt laminating adhesives. Such laminates are substantially free from volatile contaminants, especially migratable isocyanates and aromatic amines. They can be produced with the properties necessary for food packaging uses, if the laminating adhesive is applied as a pre-formed film to the first substrate, prior to laminating to a second substrate.

Lamination can be done either in-line or off-line. For off-line laminating, a substrate is preferably pre-coated with a hot melt adhesive, and this pre-coated film is later laminated to a second substrate by heat sealing. In-line lamination of the two films can be done directly in the nip, or in a second nip (the laminating station) using a release-roller in the first nip to squeeze out any entrapped air between the first film and the extruded (“pre-formed”) adhesive film. Entrapped air can also be squeezed out using this same technique for off-line lamination.

Such pre-formed adhesive films can be generated using non-contact coating methods. Thus, film-on-film laminates using solvent-free hot melt adhesives can be produced, by non-contact coating of the adhesive onto one of the films and then contacting and, in case, nipping the two films. A corresponding disclosure can be found in Applicant's earlier application PCT/EP98/01588, incorporated herein by reference, especially where the coating method, the selection of film and other substrate materials and the selection of adhesives is concerned.

The present invention further relates to a method of forming a laminate for food packaging comprising:

a) positioning a slot nozzle at least 0.5 mm spaced away from a first substrate and advancing said first substrate along a path;

b) applying a non-reactive hot melt adhesive to a surface of said first substrate from said slot nozzle; and

c) mating a second substrate with the adhesive bearing surface of said first substrate to form a laminate that has reduced contamination of packaged goods by volatile and/or migratable organic materials.

Preferably, the adhesive is applied directly to said first substrate surface, i.e. it does not contact anything solid between the point in time when the adhesive leaves the slot nozzle and the point in time when the adhesive first contacts the substrate.

However, in some applications, it may be advantageous that the adhesive is applied from the slot nozzle to a transfer device such as a roller or transfer tape, and is then coated onto the substrate surface from said roller or tape. Also in such methods, the slot nozzle will preferably not be in contact with the transfer device. In such cases, the nozzle will be positioned spaced at least 0.5 mm away from the surface of said transfer device, and may of course be much more distanced from the substrate.

Lastly, the invention is concerned with methods of packaging articles which are intended to come into contact with mammalian bodies, especially humans, and among these specially with items for ingestion and mouth contact, such as food, drink, medicine and toy items such as baby toys, and with correspondingly packaged such articles.

### BRIEF DESCRIPTION OF THE DRAWINGS

FIG. 1A shows the basic structure of a coating and laminating equipment suitable for practicing the present invention.

FIGS. 1B and 1C show other structures of a coating and lamination equipment also suitable for practicing the present invention.

FIGS. 2 through 10 show preferred equipment for practicing the present invention.

### DETAILED DESCRIPTION OF THE INVENTION

The flexible food packaging items of the invention will often be in the form of a bag or pouch, which can be sealed, such as heat-sealed, as is customary in the food packaging industry. Alternatively, the invention's flexible food packaging items can be in the form of a web or sheet material for the production of such bags or pouches, or for wrapping purposes. It is preferred that the pre-forming of the hot melt laminating adhesive film, e.g. by the non-contact coating method as already mentioned, occurs during the in-line production of the laminate material. To achieve this, the devices as e.g. shown in already mentioned PCT/EP98/01588 can be used. The amount of hot melt laminating adhesive used corresponds to the typical range of area weights in this type of laminate, but will generally be at the lower end thereof, since the non-contact coating method employed in this invention permits the use of very low area weights without causing problems such as streaking.

Coating weights of no more than about 20 g/m², preferably no more than about 10 g/m², more preferable from about 2 to about 6 g/m², are realized.

It is surprising that this non-contact coating method is particularly suitable for food packaging, Thus the food packaging laminates of the present invention generally use the typical film substrates known in the art. Thus, the film material will often be a polyolefin such as LDPE, PE or PP, or a polyester such as PET; the second substrate will often be another, often thicker polyolefin such as PE or PP, or a PET or nylon film. Metalized films such as metalized PP or PET can be used. The films used in the invention are generally heat-sealable. Corresponding film and substrate materials are e.g. disclosed by B. S. Glassbrenner, “Third Generation Solventless Laminating Adhesives for the Flexible Packaging Market”, TAPPO 1996 Polymers, Laminations and Coatings Conference, the contents of which are hereby incorporated by reference.

Film-to paper laminates for the graphical industry using hot melt laminating adhesives are e.g. described in U.S. Pat. No. 5,958,178.

It can be specifically advantageous to use biodegradable materials, especially biodegradable hot melt adhesives and films, in the context of this invention. Some biodegradable materials are e.g. disclosed in applicant's PCT/US94/09666, incorporated herein by reference.

These and more types of hot melt adhesives can be used with this coating method to produce reduced monomers or volatile organics without drying or solvent evaporating steps, and can achieve low levels of adhesive coating. This is especially important for food packaging. While reactive solvent or water-based emulsions and solvent-less reactive adhesives have to be carefully prepared to achieve adhesives with low levels of monomers, oligomers as well as other impurities, it is easier to achieve such low levels with thermoplastic materials suitable for food packaging, especially when low amounts are used.

The preferred adhesives in the context of the present invention comprises those disclosed in PCT/EP98/01588. It is preferred to use non-reactive hot melt adhesives based on copolymers of olefins and (meth-)acrylic acid; copolymers of olefins and (meth-)acrylic acid derivatives; copolymers of olefin and (meth-)acrylic acid esters; copolymers of olefins and vinylic compounds; poly-α-olefins, especially atactic poly-α-olefins (APAOs); thermoplastic synthetic rubber; metallocen-catalysed polymers, especially based on ethylenes and/or propylene; ionomers and especially copolymers; and mixtures of two or more of these thermoplastic polymers.

Specifically, useful ones include EMA, EnBA, EVA, or ethylene copolymers, blended with aliphatic hydrocarbon resins, aromatic hydrocarbon resins, wood or colophonium resins and polyethylene or polyethylene wax, or thermoplastic materials such as polyolefins, especially polyethylene, polypropylene, amorphous polyolefins such as Vestoplast 703.RTM. (Hüls) and the like. One especially useful hot melt adhesives includes Advantra®, where low monomer content, narrow molecular weight distribution, and low viscosity for easier coating without the need for additives and diluents are possible.

Specific advantages can be obtained where the thermoplastic polymer has two or even three different EnBA components, which differ in the amount of ester, in the melt flow index, or in the melting point or softening temperature range. It is specifically preferred that the thermoplastic polymer comprises at least two EnBAs with differ by a factor of at least 4 and up to 10 in their melt flow index (MFI), expressed, as usual, in grams per 10 minutes.

Uncompounded thermoplastic materials such as polyolefins, especially polyethylene, polypropylene, amorphous polyolefins such as Vestoplast 70® (Hüls), polyesters, polyamides and the like, may also be suitable as laminating adhesives of the present invention.

A preferred type of polyolefin, typically described as “metallocene polyolefins”, is produced with a single-site catalyst resulting in a homogenous distribution of comonomer branching, and a narrow molecular weight distribution, i.e., a molecular weight distribution, M_{w}/Mₙ, less than or equal to 3, preferably less than or equal to 2.5. The connotation “metallocene” is not meant in any way to be limiting regarding the specific catalyst used in the process of manufacturing the copolymer, but merely an abbreviated description of the homogenously branched linear or substantially linear polymer structures themselves.

By the term homogenous, it is meant that any comonomer is randomly distributed within a given interpolymer molecule and substantially all of the interpolymer molecules have the same ethylene/comonomer ratio within that interpolymer. The DSC melting peak of homogenous linear and substantially linear ethylene polymers will broaden as the density decreases and/or as the number average molecular weight decreases. However, unlike heterogeneous polymers, when a homogenous polymer has a melting peak greater than 115° C. (such as is the case of polymers having a density greater than 0.940 g/cm³), such polymers do not additionally have a distinct lower temperature melting peak.

In addition or in the alternative, the homogeneity of the polymers is typically described by the SCBDI (Short Chain Branch Distribution Index) or CDBI (Composition Distribution Branch Index) and is defined as the weight percent of the polymer molecules having a comonomer content within 50 percent of the median total molar comonomer content. The SCBDI of a polymer is readily calculated from data obtained from techniques known in the art, such as, for example, temperature rising elution fractionation (abbreviated herein as “TREF”) as described, for example, in Wild et al., Journal of Polymer Science, Poly. Phys. Ed., Vol. 20, p. 441 (1982), in U.S. Pat. No. 4,798,081 (Hazlitt et al.), or in U.S. Pat. No. 5,089,321 (Chum et al.) the disclosures of all of which are incorporated herein by reference. The SCBDI or CDBI for the homogenous linear and for the substantially linear ethylene/.α-olefin polymers used in the present invention is preferably greater than 50 percent.

Heterogeneous polymers are ethylene/.α-olefin interpolymers characterized as having a linear backbone and a DSC melting curve having a distinct melting peak greater than 115° C. attributable to a high density fraction. Heterogeneous interpolymers will typically have an M_{w}/Mₙ greater than 3 (when the density of the interpolymer is less than about 0.960 g/cc) and will typically have a CDBI less than or equal to 50, indicating that such interpolymers are a mixture of molecules having differing comonomer contents and differing amounts of short chain branching.

The homogenous polyethylenes useful in this invention fall into two broad categories, the linear homogenous polyethylenes and the substantially linear polyethylenes. Both are known.

Homogenous linear ethylene polymers have long been commercially available. As exemplified in U.S. Pat. No. 3,645,992 to Elston, homogenous linear ethylene polymers can be prepared in conventional polymerisation processes using Ziegler-type catalysts such as, for example, zirconium and vanadium catalyst systems. U.S. Pat. No. 4,937,299 to Ewen et al. and U.S. Pat. No. 5,218,071 to Tsutsui et al. disclose the use of metallocene catalysts, such as catalyst systems based on hafnium, for the preparation of homogenous linear ethylene polymers. Homogenous linear ethylene polymers are typically characterized as having a molecular weight distribution M_{w}/Mₙ, of about 2. commercially available examples of homogenous linear ethylene polymers include those sold by Mitsui Petrochemical Industries as Tafmer™ resins and by Exxon Chemical Company as Exact™ resins.

The substantially linear ethylene polymers (SLEPs) are homogenous polymers having long chain branching. They are disclosed in U.S. Pat. Nos. 5,272,236 and 5,272,272, the disclosures of which are incorporated herein by reference. SLEPs are available from The Dow Chemical Company as polymers made by the Insite™ Process and Catalyst Technology, such as Affinity polyolefin plastomers (POPs). SLEPs can be prepared via the solution, slurry, or gas phase, preferably solution phase, polymerisation of ethylene and one or more optional α-olefin comonomers in the presence of a constrained geometry catalyst, such as is disclosed in European Patent Application 416,815-A, incorporated herein by reference. The constrained geometry catalysts are described in more detail later.

The term “substantially linear” means that, in addition to the short chain branches attributable to homogenous comonomer incorporation, the ethylene polymer is further characterized as having long chain branches in that the polymer backbone is substituted with an average of 0.01 to 3 long chain branches/1000 carbons. Preferred substantially linear polymers for use in the invention are substituted with from 0.01 long chain branch/1000 carbons to 1 long chain branch/1000 carbons, and more preferably from 0.05 long chain branch/1000 carbons to I long chain branch/1000 carbons. In contrast to the term “substantially linear”, the term “linear” means that the polymer lacks measurable or demonstrable long chain branches, i.e., the polymer is substituted with an average of less than 0.01 long chain branch/1000 carbons.

For ethylene/α-olefin interpolymers, the long chain branch is longer than the short chain branch that results from the incorporation of the α-olefin(s) into the polymer backbone. Each long chain branch has the same comonomer distribution as the polymer backbone and can be as long as the polymer backbone to which it is attached.

The presence of long chain branching can be determined in ethylene polymers by using C¹³ nuclear magnetic resonance (NMR) spectroscopy and is quantified using the method described by Randall (Rev. Macromol. Chem. Phys., C.29, V.2&3, p. 285-297), the disclosure of which is incorporated herein by reference.

As a practical matter, current C¹³ nuclear magnetic resonance spectroscopy cannot determine the length of a long chain branch in excess of six carbon atoms. However, there are other known techniques useful for determining the presence of long chain branches in ethylene polymers, including ethylene/1-octene interpolymers. Two such methods are gel permeation chromatography coupled with a low angle laser light scattering detector (GPC-LALLS) and gel permeation chromatography coupled with a differential viscometer detector (GPC-DV). The use of these techniques for long chain branch detection and the underlying theories have been well documented in the literature. See, e.g., Zimm, G. H. and Stockmayer, W. H., J. Chem. Phys., 17, 1301 (1949) and Rudin, A., Modem Methods of Polymer Characterization, John Wiley & Sons, New York (1991) pp. 103-112, both of which are incorporated by reference. Further, and in particular, A. Willem de Groot and P. Steve Chum, both of The Dow Chemical Company, at the Oct. 4, 1994, conference of the Federation of Analytical Chemistry and Spectroscopy Society (FACSS) in St. Louis, Mo., presented data demonstrating that GPC-DV is a useful technique for quantifying the presence of long chain branches in substantially linear ethylene polymers.

The empirical effect of the presence of long chain branching in the substantial linear ethylene/α-olefin interpolymers used in the invention is manifested as enhanced rheological properties which are quantified and expressed herein in terms of gas extrusion rheometry (GER) results and/or a melt flow I₁₀/I₂, which may be varied independently of the M_{w}/Mₙ.

Substantially linear ethylene polymers are further characterized as having:

(a) a melt flow ratio, I₁₀/I₂≧5.63,

(b) a molecular weight distribution, M_{w}/Mₙ as determined by gel permeation chromatography and defined by equation:

(M_{w}/Mₙ) (I₁₀/I₂)−4.63,

(c) a critical shear stress at the onset of gross melt fracture, as determined by gas extrusion rheometry, of greater than 4×10⁶ dynes/cm² or a gas extrusion rheology such that the critical shear rate at onset of surface melt fracture for the substantially linear ethylene polymer is at least 50 percent greater than the critical shear rate at the onset of surface melt fracture for a linear ethylene polymer, wherein the substantially linear ethylene polymer and the linear ethylene polymer comprise the same comonomer or comonomers, the linear ethylene polymer has an I₂, M_{w}/Mₙ and density within ten percent of substantially linear ethylene polymer and wherein the respective critical shear rates of the SLEP and the linear ethylene polymer are measured at the same melt temperature using a gas extrusion rheometer, and

(d) a single differential scanning calorimetry, DSC, melting peak between −30 and 150° C.

An apparent shear stress versus apparent shear rate plot is used to identify the melt fracture phenomena and quantify the critical shear rate and critical shear stress of ethylene polymers.

According to Ramamurthy in the Journal of Rheology, 30 (2), 337-357, 1986, the disclosure of which is incorporated herein by reference, above a certain critical flow rate, the observed extrudate irregularities may be broadly classified into two main types: surface melt fracture and gross melt fracture.

Surface melt fracture occurs under apparently steady flow conditions and ranges in detail from loss of specular film gloss to the more severe form of “sharkskin”. Herein, as determined using the above-described GER, the onset of surface melt fracture (OSMF) is characterized at the beginning of losing extrudate gloss at which the surface roughness of the extrudate can only be detected by 40× magnification. The critical shear rate at the onset of surface melt fracture for the substantially linear ethylene polymers is at leas 50 percent greater than the critical shear rate at the onset of surface melt fracture of a linear ethylene polymer having essentially the same I₂ and M_{w}/Mₙ.

Gross melt fracture occurs at unsteady extrusion flow conditions and ranges in detail from regular (alternating rough and smooth, helical, etc.) to random distortions. For commercial acceptability to maximize the performance properties of films, coatings and moldings, surface defects should be minimal, if not absent. The critical shear stress at the onset of gross melt fracture for the substantially linear ethylene polymers, especially those having a density >0.910 g/cc, used in the invention is greater than 4×10⁶ dynes/cm². The critical shear rate at the onset of surface melt fracture (OSMD) and the onset of gross melt fracture (OGMF) will be used herein based on the changes of surface roughness and configurations of the extrudates extruded by a GER. Preferably, the substantially linear ethylene polymer will be characterized by its critical shear rate when used as the first ethylene polymer of the invention and by its critical shear stress when used as the second ethylene polymer of the invention.

The adhesive can also comprise up to 100% of at least one EMA, EnBA or homogenous linear polymer. Preferably, the thermoplastic polymer component comprises at least two, preferably three, different EnBA components, wherein one EnBA component has a melt flow index which is at least four times and up to 10 times higher than the melt flow index of at least one other EnBA component, said melt flow index being in units of gram per 10 minutes. If the thermoplastic polymer comprises more than one EnBA component, said EnBA components differing in the ester content, in the melt flow index and/or the melting point or softening point.

Tackifying resins can be used and are selected from aliphatic and aromatic hydrocarbon resins, especially hydrogenated aliphatic hydrocarbon resins and α-methyl styrene resins, colophonium resins and colophonium ester resins, especially hydrogenated such colophonium and colophonium ester resins. The preferred tackifying resin is hydrogenated aliphatic hydrocarbon resin, and α-methyl styrene resin, with the amounts of from about 10 to about 40% by weight.

The hot melt laminating adhesive can additionally comprise at least one other polymer, especially a polyolefin such as polyethylene or a polyethylene wax.

The amount of preferred ingredients present in the adhesive is tabulated as follows:

| | | Preferred | Most preferred |
|---|---|---|---|
| Thermoplastic | 10-100% | 20-80% | 35-60% |
| (co-)polymer | | | |
| Aliphatic hydro- | 0-50% | 0-45% | 0-40% |
| carbon resin | | | |
| Aromatic hydro- | 0-20% | 0-15% | 0-10% |
| carbon resin | | | |
| Colophonium resin | 0-40% | 0-35% | 0-30% |
| Polyethylene or | 0-20% | 0-15% | 0-10% |
| polyethylene wax | | | |

as well as, in case, small amounts of customary additives.

The adhesive film is continuous, even at low coating weights and the laminate does not easily exfoliate or delaminate upon sealing. The adhesive peel strength ranges from 0.5 N/15 mm to film destruction, depending on the substrates, adhesive formulation used as well as angle and rate of peeling.

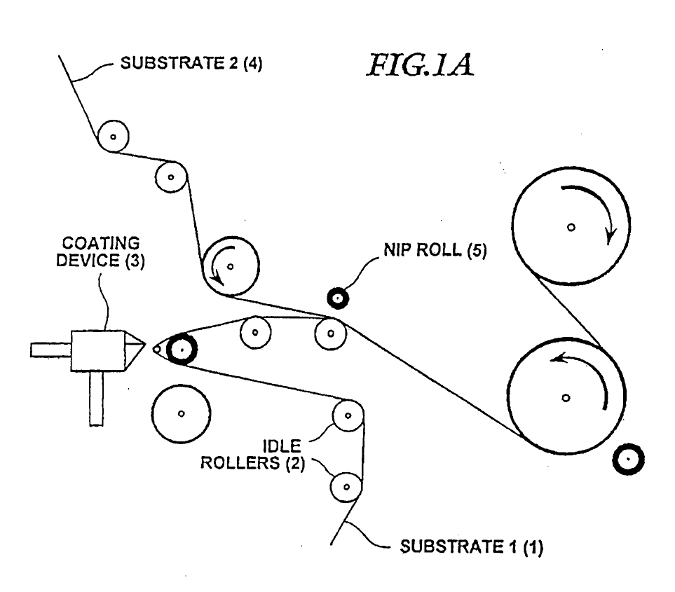

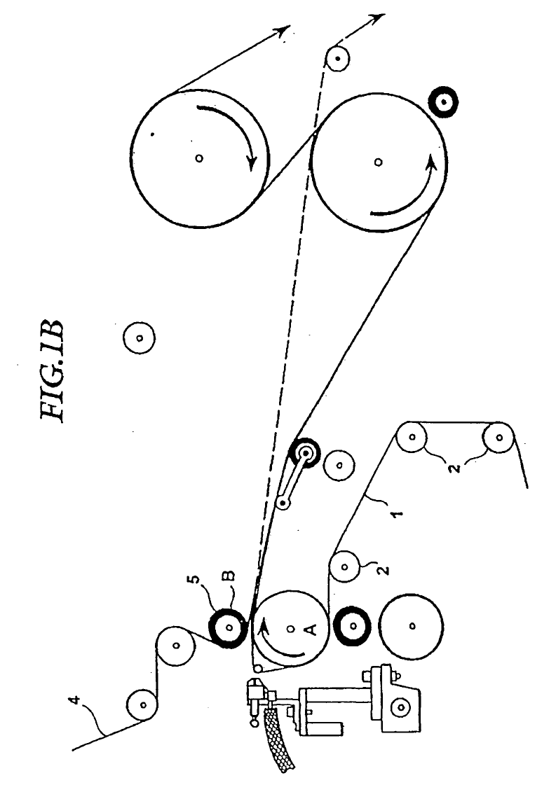

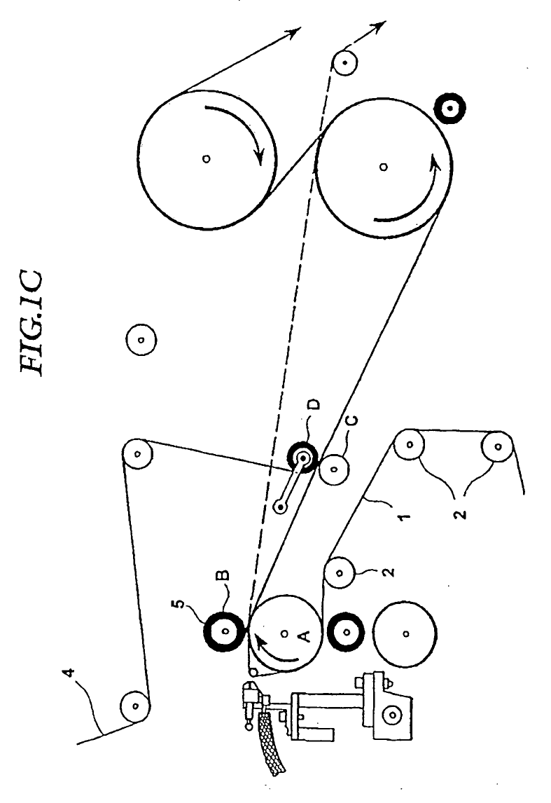

The structure of the machine can be that or similar to that shown in FIGS. 1A-1C. FIGS. 1A and 1B show an embodiment where a thermoplastic composition is released from a coating device (3) onto a first substrate (1), and a second substrate (4) is then disposed upon the free surface of the coated adhesive, by a nip roll (5). It is to be understood that this arrangement can be modified in other embodiments and especially that the second substrate (4) need not be used in all cases. Then, the nip roll (5) can be employed to nip the thermoplastic composition directly to the first substrate. For such embodiments, the nip roll (5) will be release-coated, e.g. may be a steel roller with a polytetrafluorethylene surface layer.

More specifically shown in FIGS. 1A and 1B, Substrate 1 (1) travels past a series of idle rollers (2) to ensure the web is in proper alignment prior to approaching the coating device (3). Substrate 2 (4) is optionally adhered to the coating surface by means of a nip roll (5). Substrate 1 is defined as the first substrate that is contacted with the substantially continuous thermoplastic film. Substrate 1 may be any substrate which is generally provided in a roll good such as non-woven, paper including release-coated paper, and a wide variety of films, foils and other materials. The embodiment of FIG. 1A, where the nip roll (5) is located fairly remote from the contact point of adhesive film and first substrate, is especially suited for the coating of porous substrates. The embodiment of FIG. 1B is especially suitable when Substrate 1 is nonporous meaning air does not readily pass through the substrate. In the case of film lamination, Substrate 1 is typically a film. Substrate 2 may also be provided in a roll good and be the same or a different material as Substrate 1.

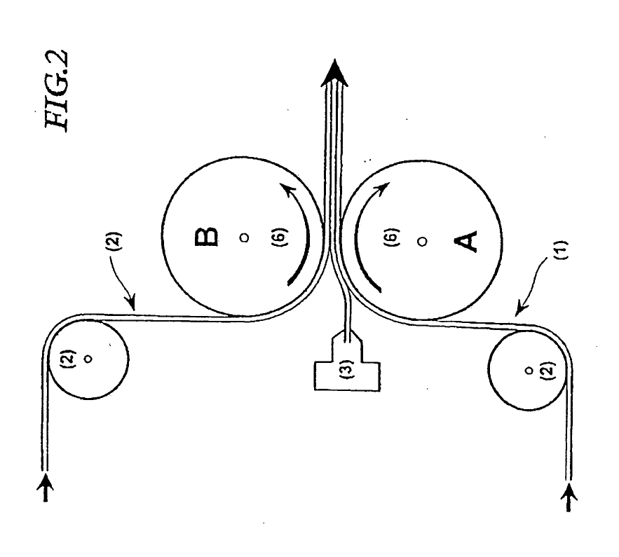

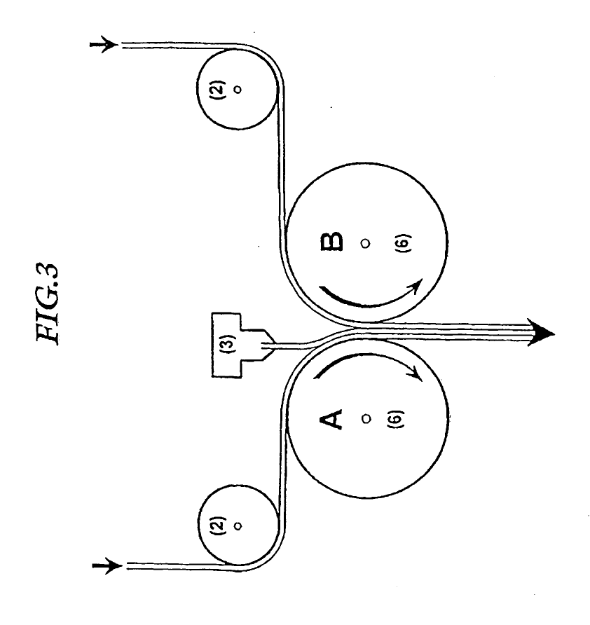

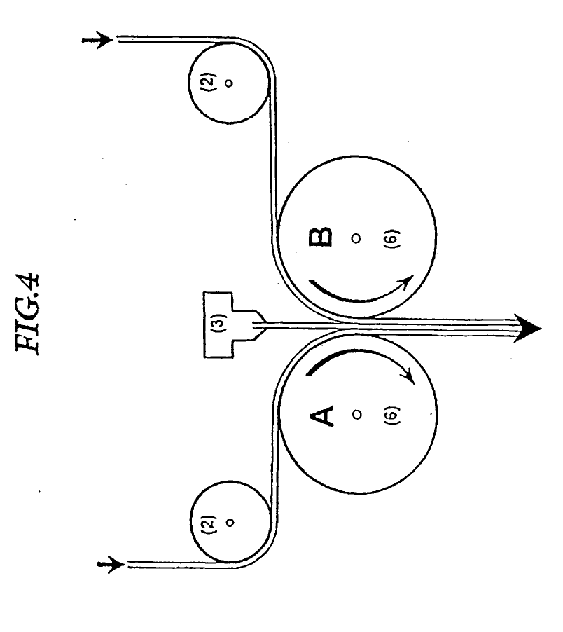

FIG. 1C shows an embodiment where the adhesive film is first nipped onto the first substrate (1) by nip roll (5), which is part of a nipping station as later shown by rolls A and B in FIGS. 2-10.

A second substrate 4 is then disposed on the free surface not in contact with the first substrate (1), at a lamination station formed by rolls C and D. With this type of machine, it is possible to nip the adhesive film directly onto the first substrate (1) by means of nip roller (5) or nip a second substrate (4) onto the first substrate and adhesive, again by means of nip roller (5). In the tests, both methods were tried. The dispensing temperature of the hot melt can range from about 90° to about 200°, preferably from about 110° to about 140° C. depending on the composition, thickness and speed of coating.

Machine speeds of up to about 500 m/minute, preferably about 350 m/minute, and more preferably about 300 m/minute are suitable. During the coating process, the adhesive film is release from the coating slot nozzle, at various distances from a first substrate (1) to be coated with the adhesive. Also, the distance of the slot nozzle from the substrate can be varied between a few millimetres and up to 500 mm and more, preferably from about 10 millimeter to about 300 millimeter, and more preferably from about 20 millimeter to about 100 millimeter, without materially affecting the quality of the coating.

When the adhesive film released from the coating slot nozzle is directly coated onto a first substrate by means of nip roller (5) provided with a release coating, the adhesive shows no tendency to adhere to the nip roller. The nip pressure can also be varied and can be as high as about 10 bars, preferably about 8 bars, and more preferably about 7 bars, when the nip roller presses against the substrate.

It is generally found that as the adhesive coated onto the first substrate leaves the nip station, no air is enclosed between the adhesive and the first substrate.

In another aspect, a second substrate can be laminated onto the adhesive layer by a second set of rollers, located in the flow path of the substrate upstream of the nip roller (5). Also these laminations, usually have no streaking, enclosed air, or other lamination defects.

The coating head can be at about 0.5 mm away from the substrate, preferably at about 2 mm, more preferably at about 10 mm, and most preferably not more than 20 mm.

The temperature at which the adhesive contacts the substrate is preferably not more than 150° C., more preferably not more than 120° C., and most preferably not more than 110° C., as it is desirable to use as substrates polymeric film that are either of low gauge, or film material that has low melting points.

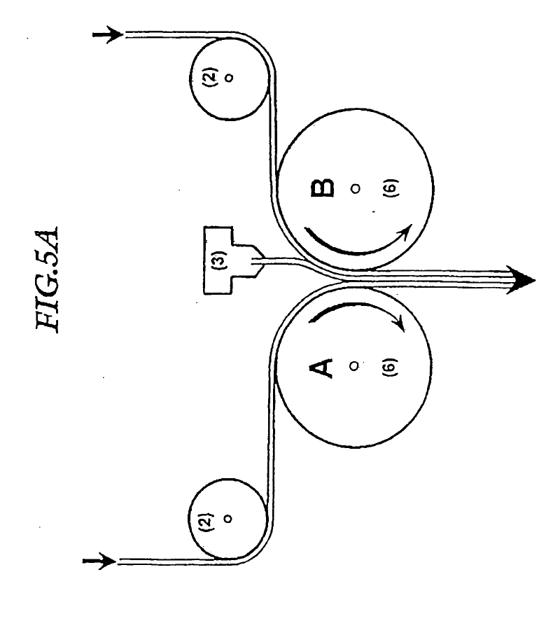

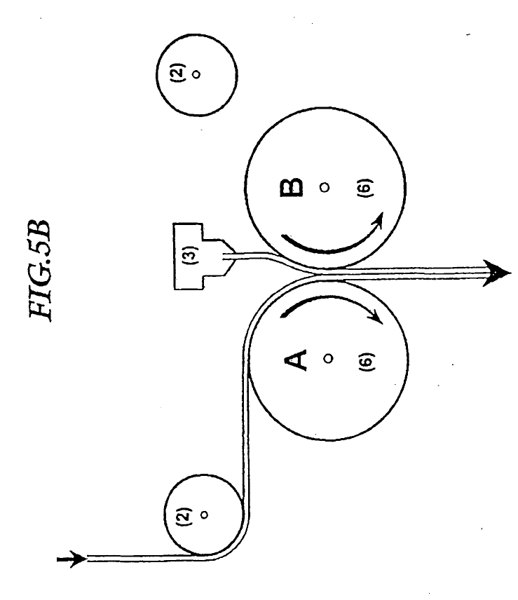

FIGS. 2-10 illustrate various preferred embodiments of the present invention wherein an extruded thermoplastic composition such as a holt melt adhesive is applied to a first substrate and then laminated to a second substrate. In each of these illustrations, Substrate 2 is optional in that the invention may alternatively involve a single continuous nonporous film formed from a non-contact coating method and coated onto a single substrate. In the absence of the second substrate, FIG. 5B represents a transfer coat application since the molten composition is first applied to a release coated roller which then contacts a first substrate at the nip. The first substrate may then by laminated to the second substrate in a subsequent step. For many food packaging laminates, the film-to-film method shown in FIGS. 2-5A is presently the most preferred lamination method.

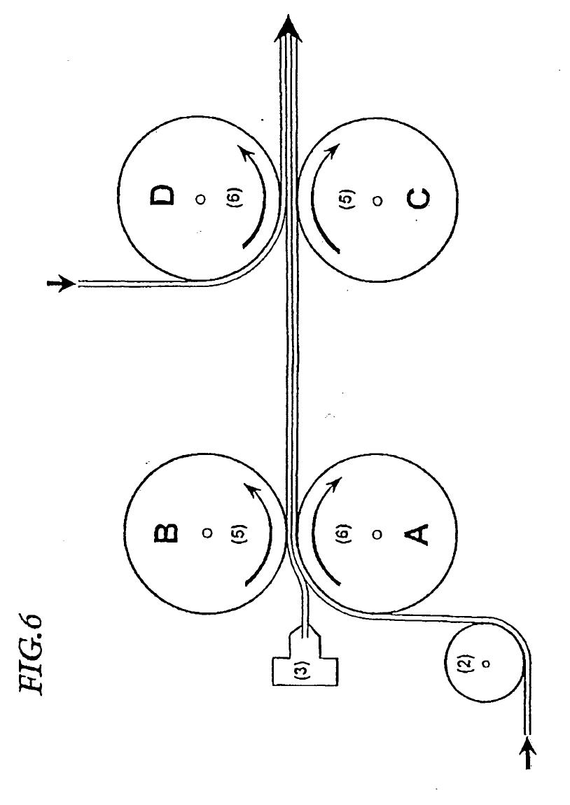

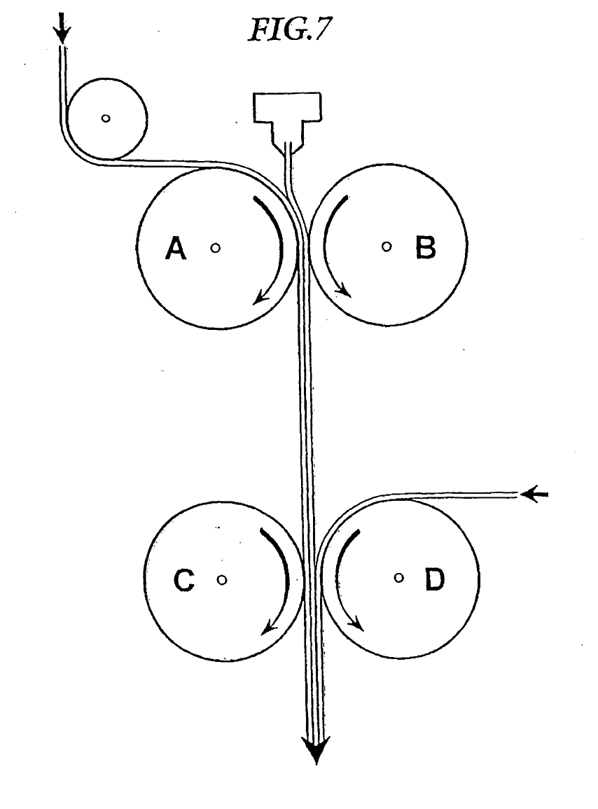

In embodiments where the thermoplastic coating or hot melt adhesive is contacted to a first substrate in the absence of a second substrate, as illustrated in FIGS. 6 and 7 it is important to have a release coating such as silicon, Teflon, or release paper on the roller (s) in contact with the adhesive or porous substrate to prevent adherence of the thermoplastic composition to the roller. The nip roller presses the air out from between the thermoplastic coating film and the substrate to insure there is no air entrapment between the first substrate and the thermoplastic composition. Roller A can be a steel cylinder to encourage heat transfer whereas roller B, typically the nip roller is rubber. In many cases it is however more preferred that roller A is rubber whereas roller B is a steel cylinder with an external release-coating (FIGS. 5B to 10).

FIGS. 2-10 demonstrate that the nozzle position may be varied from perpendicular positions to parallel positions with respect to the position of the substrate.

FIGS. 6-9 show further embodiments which are specifically suitable for film-to-film laminations for food packaging.

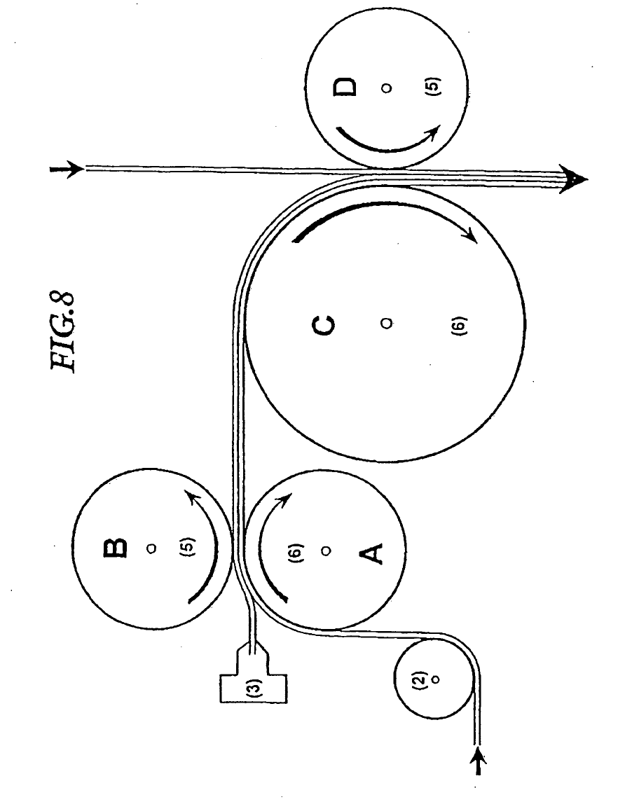

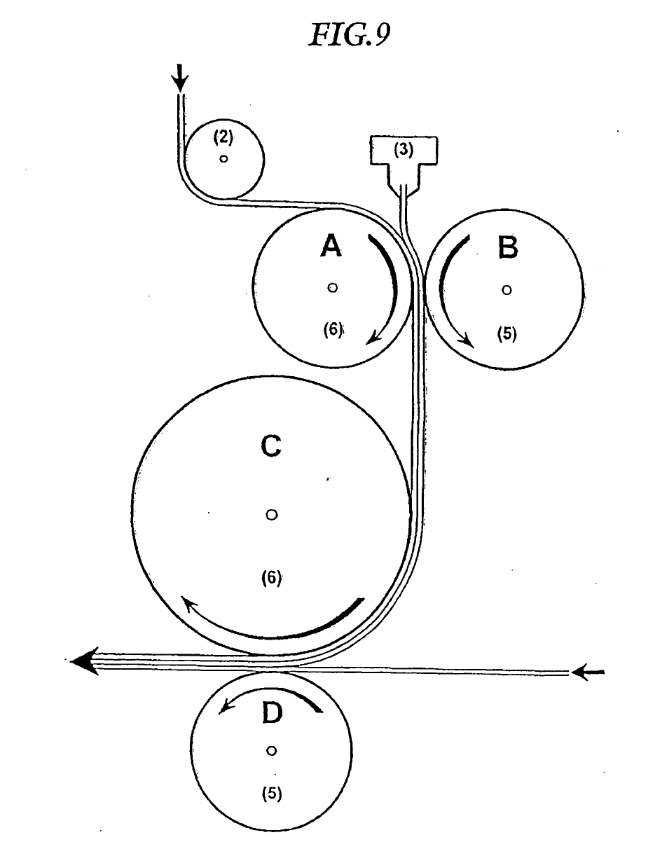

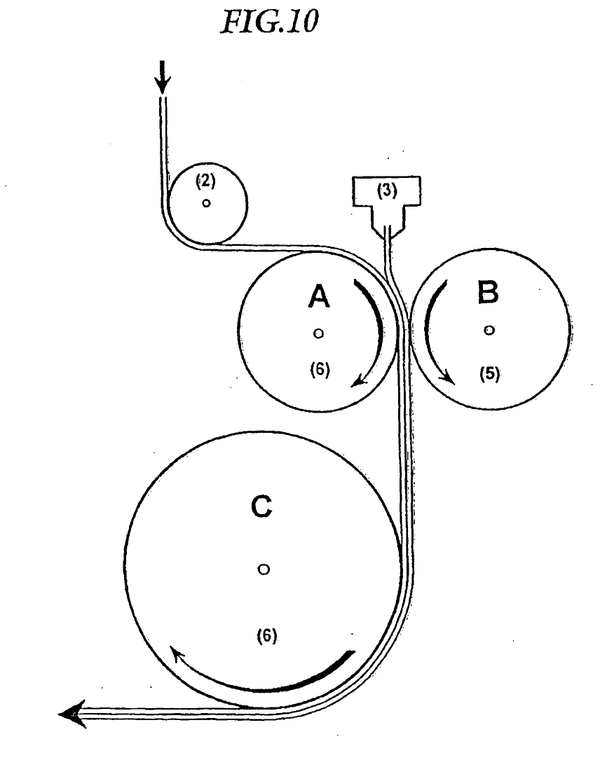

FIGS. 8 and 9 illustrate a second substrate being laminated to the first substrate at a position farther from the coating device. In this embodiment, it is preferred that roller C be heated to reactivate or extend the open time of the hot melt adhesive or thermoplastic coating prior to being laminated to the second substrate. The temperature of roller C can vary between about 30-100° C. for lamination between rollers C and D. Alternatively, roller C may be a chill roll to hasten the speed of set of the thermoplastic coating or hot melt adhesive. This can be useful where the coating is produced for intermediate storage. The substrate laminated in the nip of rollers C and D can be either in web form, or in the form of sheets (FIGS. 8 and 9). As shown in FIG. 10, where roller C is a chill roll, the inventive method can be used to produce substrates such as films coated on one side with a thermoplastic composition, which can e.g. be used for heat sealing applications. Where this is desired, a further layer of a release paper can of course be added, as shown in FIG. 9, to protect the heat-sealing material e.g. for intermediate storage.

The coating device is positioned at a distance of at least 0.5 mm, preferably at least 2 mm, from the substrate (or the release coated roller in the case of transfer coating in the absence of a second substrate—FIG. 5B). The maximum distance the coating device may be positioned from the substrate is only limited by practicality, particularly when the coating device is positioned substantially vertically. Preferably, the distance is less than about 5 m, preferably less than about 3 m, more preferably less than about 1 m, even more preferably less than about 500 mm, and most preferably from about 2 to 20 mm, depending on the properties of the thermoplastic composition being coated. It is typically advantageous that the area between the coating device and substrate be shielded during coating from air-borne contaminants and air currents to prevent distortion of the coating prior to contacting the substrate. This is particularly the case when the distance between the coating device and substrate is greater than about 500 mm.

The distance is largely dictated by the viscosity and open time of the thermoplastic composition being coated. In the case of producing film coatings on fibrous substrates in this manner, it is surmised that the thermoplastic composition cools sufficiently in its suspended state such that it has built in viscosity and cohesive strength to the extent that any filaments or fibers present on the substrate surface cannot penetrate the coating, yet the thermoplastic composition is molten enough to adequately adhere to the substrate. The greater the distance between the coating device and the nip roller, the more the hot melt adhesive or coating will cool prior to contacting the first substrate. For some adhesive compositions, this cooling will adversely affect the adhesion (or anchorage) to the substrate. Therefore, the substrate may be passed over a heated roller prior to being nipped, or a heated nip roller may be employed if the distance between the nip roller and the coating device causes the coating or adhesive to cool to the extent that it will no longer adequately adhere or anchor to the substrate. Also, transfer coating as shown in FIG. 5B can be employed, where the release-coated nip roller B can be temperature-controlled by a heating cooling system such as passing cooling fluid through roller B.

The diameter of rolls A and B is preferably about 15 mm to about 50 mm.

Thereafter, the sufficiently cooled coating contacts the substrate surface and adheres to the surface without deeply penetrating into the substrate. If the thermoplastic coating is of such a composition that it substantially detackifies after sufficient cooling, the laminate of the coated substrate, thus formed, can be rolled up and stored.

Alternatively this can be achieved by placing a release coated second substrate, such as a silicone-coated paper, on the surface of the adhesive coating. The laminate can then be used at some later time. The laminate can be bonded by any suitable bonding technique including ultrasonic bonding, heat sealing, or more commonly adhesive bonding.

Preferably, the coating is done “in-line” immediately before any further processing. An example of an in-line process for which the invention is particularly well suited may be found in DE 195 46 272 C1 to Billhöfer Maschinenfabrik GmbH, incorporated herein by reference. Suitable slot nozzles, made by INATEC GmbH of Langenfeld, Germany, are shown in U.S. Pat. No. 5,958,178.

Preferably, the laminating material is a synthetic film material, especially a clear and transparent film material as is customarily used for such laminations.

Typically such film materials comprise plane or embossed films, which are at least substantially made from oriented polypropylene, polyethylene, polyesters such as Mylar®, polyacetate, nylon, celluloseacetate, and so forth having a thickness of about 5 microns to about 50 microns. These films are commonly laminated or sealed to printed paper or boardstock. Composite materials are commonly produced including film-to-film and film-to-foil and metalized substrates are commonly used for laminates. These types of laminates are commonly found in such industries as graphic arts and packaging. Using the method of the invention, such laminates can be produces using non-reactive hot melt adhesives instead of the commonly used reactive adhesives.

Generally, the exit temperature of the thermoplastic composition will be less than about 240° C., and thus much lower than typical polymer extrusion temperatures, which are of the order of 300° C. Although the temperature of the thermoplastic composition as it exits the coating device may range from about 80° C. and about 180° C. or more, the non-contact coating system of the present invention allows coating to be accomplished at extremely low temperatures. For this embodiment it is preferred that the thermoplastic composition be coated at a temperature less than 160° C., more preferably less than about 140° C., even more preferable less than about 120° C. and even more preferable less than about 110° C. As mentioned previously, heat sensitive materials can also be coated in this manner by employing higher coating temperatures in combination with increasing the distance between the coating device and the substrate to be coated to allow for sufficient cooling. Materials which are normally too sensitive mechanically and/or thermally (e.g. very low gauge films) for customary coating methods can therefore be coated using the method of the present invention. Such sensitive materials include low gauge polyethylene materials and the like.

A substantial advantage of the present invention is that a substantially continuous coating layers can be made from hot melts at very low coating weights. Even with customary commercially available hot melts, continuous layers can be produced at coating weights ranging from about 0.5 g/m² to as much as 50-60 g″, preferably at coating weights of not more than about 20 g/m², more preferably at coating weights of not more than 10 g/m², even more preferably between 3 g/m² and 5 g/m² and most preferably less than 3 g/m². However, coating weights higher than 60 g/m² may be useful for other applications wherein reducing the mechanical and heat-induced stresses is of primary importance.

The very thin coatings which can be produced according to the invention not only contribute to the economical advantages of the inventive method, but also makes it possible to achieve a very much reduced stiffness of the material, which thus comes much closer, in its properties, to uncoated substrates.

The invention also concerns foodstuff items packaged in accordance with the invention. The use of such flexible laminating materials as packaging material for the food, drink and drug industries has the major advantage of avoiding contamination of the packaged items by volatile and/or migratable packaging material components such as monomers. This makes it possible to produce packaging laminate materials for the food industry advantageously from solvent-free hot melt laminate adhesives, without incurring the danger of contaminating the food with monomers and their reacting products. At the same time, optically very advantageous laminates are obtained, which are not inferior, but quite often superior, in these aspects than state-of-the-art laminates.

Specifically, the present invention is related to the use of a flexible laminate material comprising a polymer plastics material film laminated onto a second substrate by means of a hot melt laminating adhesive, as a packaging material to reduce contamination of packaged goods, especially food, by volatile packaging material components, such as monomers or ologomers. Such volatile and/or migratable components can include isocyanates and/or aromatic amines.

These foodstuffs can be selected from all foodstuffs which have been packaged, are currently packaged or may in the future be packaged using laminated packaging material as above disclosed. Specifically, these will be items such as medicine, snack foods and confectionery, aqueous and moist foods, dry foodstuffs, coffee, tea and such goods, heat-treated and steamed, as well as autoclaved goods, but also fresh fruit, fresh vegetables, fresh meats, fish and cheese, as well as corresponding items for deep freezing and other low temperature preservation purposes. Vacuum preservation packaging is included, and the packed food items of the invention further include prepared food for reheating, as well as beverages. Thus, the invention includes the packaging of milk in film bags, as well as fruit and vegetable juices and alcoholic beverages such as wine.

In addition, such laminates can be used as capseals for various food, drink and medicine packaging, as well as aseptic packaging of food and drink items mentioned above. Also, other non-food uses can include packaging of toys for example, for small children and babies, who may put such items in their mouths, are expressly within the scope of the present invention. Also, boxes and pouches for baked goods are contemplated.

The present invention is further illustrated by the following non-limiting examples.

### EXAMPLES

Hot melt adhesives were produced from different thermoplastic polymers, tackifiers and plasticizers as shown in Table 1 below:

### Examples 1-10

TABLE 1

| Ingredients | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| Lotryl ® 17 BA 07 | 23 | 40 | 35 | 10 | 23 | — | — | — | — | — |
| EnBA copolymer | | | | | | | | | | |
| Lotryl ® 35 BA 40 | 15 | —— | — | 20 | 15 | 20 | 15 | 15 | — | — |
| EnBA copolymer | | | | | | | | | | |
| Lotryl ® 35 BA 320 | 17 | — | — | 30 | 17 | 10 | 16 | 15 | 20 | 20 |
| EnBA copolymer | | | | | | | | | | |
| Escorene ® UL | — | — | — | — | — | 20 | 24 | 23 | 45 | 45 |
| 150 - 19 | | | | | | | | | | |
| EVA copolymer | | | | | | | | | | |
| AC-8 | 5 | 10 | — | — | 5 | — | 5 | — | 5 | — |
| Polyethylene wax | | | | | | | | | | |
| AC 540 | — | — | — | — | — | — | — | — | — | 5 |
| Polyethylene wax | | | | | | | | | | |
| Paraflint ® C 80 | — | — | — | — | — | 10 | — | — | — | — |
| Polyethylene wax | | | | | | | | | | |
| Mobil Wax 145 | — | — | — | — | — | — | — | 5 | — | — |
| paraffin wax | | | | | | | | | | |
| Escorez ® 5300 | 28 | 38 | 38 | 38 | — | 23 | 28 | 30 | 20 | 20 |
| Hydrocarbon resin | | | | | | | | | | |
| Foral ® AX | 10 | 10 | 25 | — | 28 | 15 | 10 | 10 | — | — |
| rosin acid resin | | | | | | | | | | |
| Kristalex ® F 85 | — | — | — | | 10 | — | — | — | — | — |
| α-methyl styrene | | | | | | | | | | |
| resin | | | | | | | | | | |
| Kristalex ® F 100 | — | — | — | — | — | — | — | — | 10 | 10 |
| α-methyl styrene | | | | | | | | | | |
| resin | | | | | | | | | | |

Hot melt adhesives corresponding to the compositions depicted in Examples 1 and 7 were coated onto substrates, using a modified PAK 600 laminating machine by Kroenert, Hamburg, Germany. The structure of this machine is basically similar to that shown in FIGS. 1A-1C. With this type of machine, it is possible to nip the adhesive film directly onto the first substrate (1) by means of nip roller (5) or nip a second substrate (4) onto the first substrate and adhesive, again by means of nip roller (5). In the tests, both methods were tried. The dispensing temperature of the hot melt was 140° C. for the composition of Example 1, and 110° C. for the composition of Example 7. These compositions showed favourable low viscosities of Examples 1 and 7.

Coatings were made on polyester film (Polyester RN 36, produced by Patz Folien, Taunusstein-Wehen, Germany) and high density polyethylene films (HDPE KC 3664.00, obtained from Mildenberger & Willing, Gronau, Germany).

Coating weights were 5 to 6 g/M² at machine speeds of approximately 70 m/minute. (In separate tests, coating weights of 2 to 3 g/m² were obtained.)

The adhesive film was released from the coating slot nozzle, at various distances from the first substrate (1) to be coated with the adhesive, in a variety of tests. In another set of experiments, it was found that the distance of the slot nozzle from the substrate could be varied between a few millimetres and up to 500 mm and more, without materially affecting the quality of the coating.

Where in these experiments, the adhesive film released from the coating slot nozzle was directly coated onto the first substrate by means of nip roller (5) provided with a release coating, it was found that the adhesive did not adhere to the nip roller. The nip pressure was not measured, but the nip roller was pressed against the substrate at a laminating pressure of 7 to 8 bar.

It was found that the adhesive coated onto the first substrate left the nip station with no air enclosed between the adhesive and the first substrate.

In other tests, a second substrate was laminated onto the adhesive layer by a second set of rollers, located in the flow path of the substrate upstream of the nip roller (5). Also these laminations, using the same films were examined for streaking, enclosed air, or other lamination defects.

The laminations thus made were all free of flaws. No streaking, enclosed air or any other defects were observed.

In a similar fashion, laminations were made using the same type of films, but the other adhesives depicted in Examples 2 to 10 of Table 1. The results were as good as those obtained with the adhesive compositions of Examples 1 and 7.

In further tests, typical food packaging items were produces and tested as follows:

Embodiment A

Laminates were produced on a modified Billhöfer “Coat 2000” laminating machine as mentioned above and equipped with an INATEC slot nozzle, using 20 μm OPP-Films, available under the trade name “Propafilm RGP” from UCB Films.

For the laminating trials, one of the films was counter-printed and the other one was metalized, i.e. the printed surface of the one film was laminated to the metalized surface of the other film. The hot melt composition used corresponds to Example 7 in Table 1. In one trial the coating weight of the hot melt was 5 g/m², in a second trial 8 g/m² and in yet another example 14 g/m² was used.

The laminates thus made were then subjected to heat-seal tests as conventional in the packaging industry.

In all cases the laminates produced were of good quality and showed no delaminating tendencies in heat-seal trials.

Embodiment B

Laminates were produced on a machine as in Embodiment A, using two 20 μm OPP-Films, available under the trade name “Propafilm RGP” from UCB Films.

For the laminating trials, one of the films was counter-printed and the other one was metalized, i.e., the printed surface was laminated to the metalized surface. (Different printing inks were used, which were also different from Embodiment A).

The hot melt composition used corresponds to Example 9 in Table 1. In one trial the coating weight of the hot melt was 5 g/m², in a second trial 10 g/m² was used.

In both cases the laminates produced were of good quality and showed no delaminating tendencies in heat-seal trials (as in Embodiment A).

Embodiment C

Laminates were produced (as above) with two 20 μm OPP-Films, available under the trade name “Trespaphan GND 20” from Trespaphan.

For the laminating trials one of the films was counter-printed and the other one was unprinted, i.e. the printed surface of the first film was laminated to the unprinted surface of the second film. (The printing colours were different from Embodiments A and B).

The hot melt composition used corresponds to Example 7 in Table 1. In one trial the coating weight of the hot melt was 2 g/m², in a second trial 5 g/m² and in yet another example 10 g/m² was used.

In all cases the laminates produced were of good quality and showed no delaminating tendencies in heat-seal trials (as above-described).

Embodiment D

Laminates were produced (as above) using 40 μm PE-film available from Huhtamaki and 400 μm PVC from MKF. Both films were unprinted. Such laminates are commonly used to produce (through heat-moulding) beakers, bowls or dishes which can be closed by heat-seal lidding. It has become rather common to use APET (atactic polyester films) instead of PVC for food packaging.

The laminates were formed both in-line, i.e. laminating the PE-film, after applying the hot melt to it, in-line onto the PVC-film. In another trial the hot melt coated PE-film was wound onto a roll and later (thus off-line), the coated PE-film was heat sealed onto the PVC-film.

The hot melt composition used for these trials corresponds to Example 10 in Table 1. The coating weight used was 10 g/m².

In both cases, i.e. with laminates produced in-line and off-line the laminates had excellent clarity and lamination strength and did not show any signs of delamination upon heat—moulding the laminates and heat-lidding the moulded dishes.

1. A method of forming a food package laminate comprising:
advancing a first substrate along a path;
applying a non-reactive hot melt adhesive to a surface of the first substrate from a slot nozzle positioned at least about 0.5 mm away from the surface of the first substrate to form an adhesive bearing surface; and
mating a second substrate with the adhesive bearing surface to form a food package laminate for use in a food package,
said food packing laminate being free from volatile organic materials, migratable organic materials and mixtures thereof.

2. The method according to claim 1, wherein the food package laminate is converted into at least a portion of a food package.

3. The method according to claim 2, wherein the food package laminate is sealable.

4. The method according to claim 1, wherein the first substrate is a polymeric film material comprising a thermoplastic polymer selected from the group consisting of a poly-α-olefin, a polyester, and mixtures thereof.

5. The method according to claim 2, wherein the polymeric film material is at least partially transparent.

6. The method according to claim 1, wherein the hot-melt adhesive comprises an area weight of not more than about 5 g/m² of the first substrate.

7. The method according to claim 1, wherein the first substrate is a polymeric film material comprising a thermoplastic polymer and wherein the thermoplastic polymer component comprises at least a first EnBa component and a second EnBa component, wherein the first EnBa component has a melt flow index which is at least about 4 times and up to about 10 times higher than a melt flow index of the second EnBa component, said melt flow index being measured in units of gram per 10 minutes.

8. The method of claim 1, wherein said nozzle is spaced apart from said substrate by not more than about 20 mm.

9. The method of claim 1, wherein said hot-melt adhesive contacts said first substrate with a temperature of not more than about 150° C.

10. The method of claim 1, wherein said non-reactive hot melt adhesive comprises polyolefin having a molecular weight distribution no greater than about 3.

11. The method of claim 1, wherein said non-reactive hot melt adhesive comprises a homogeneous linear ethylene/alpha-olefin interpolymer, substantially linear ethylene/alpha-olefin interpolymer or a combination thereof.

12. A method of forming a food package laminate comprising: applying a non-reactive hot melt adhesive to a surface of a transfer device from a slot nozzle positioned at least about 0.5 mm away from the transfer device;
transferring said adhesive from the transfer device to a surface of a first substrate to form an adhesive bearing surface; and
mating a second substrate with the adhesive bearing surface of the first substrate to form a food package laminate,
said food package laminate being free from volatile organic materials, migratable organic materials and mixtures thereof.

13. The method according to claim 12, wherein the food package laminate is converted into at least a portion of a food package and wherein the food package is selected from the group consisting of a bag, pouch, and a box.

14. The method according to claim 13, wherein the food package laminate is sealable.

15. The method according to claim 12, wherein the first substrate is a polymeric film material comprising a thermoplastic polymer.

16. The method according to claim 15, wherein the polymeric film material is printable.

17. The method of claim 1, wherein the hot melt adhesive comprises a homogeneous linear ethylene/alpha-olefin interpolymers or substantially linear ethylene/alpha-olefin interpolymers having a short chain branch distribution index greater than about 50%.

18. The method of claim 1, wherein the hot melt adhesive comprises substantially linear homogeneous ethylene polymer.

19. The method according to claim 12, wherein the hot melt adhesive comprises an area weight of not more than about 5 g/m² of the first substrate.

20. The method according to claim 12, wherein the hot melt adhesive additionally comprises at least one polymer selected form the group consisting of polyethylene, polyethylene wax and mixtures thereof.

21. The method of claim 12, wherein said hot melt adhesive contacts said first substrate at a temperature of not more than about 120° C.

22. A method of packaging goods intended to be brought into contact with a mouth of a mammal such that the goods remain essentially free of contaminants selected from the group consisting of volatile organic materials, migratable organic materials and mixtures thereof typically found in packaging materials comprising the steps of:
forming a flexible laminate material that is substantially free of the contaminates by laminating a polymeric film material onto a substrate using a hot-melt laminating adhesive;
and covering at least a portion of the goods with the flexible laminate material.

23. The method according to claim 22, wherein said contaminant comprises material selected from the group consisting of isocyanates, aromatic amines and mixtures thereof.

24. The method according to claim 22, wherein said goods are selected from the group consisting of medicine, toys, snack foods, confectionery, aqueous and moist foods, dry foodstuffs, milk, coffee, tea, fresh fruit, fresh vegetables, fresh meats, fish, and corresponding frozen items.

25. An article comprising:
flexible food packaging laminate comprising a first substrate having a pre-formed non-reactive hot melt laminating adhesive on at least a first surface of the first substrate, a second substrate laminated onto at least a portion of the first surface; and
a food item in association with the flexible food packaging laminate;
the food item being essentially free of contamination by volatile organic material from the packaging laminate, migratable organic material from the packaging laminate, or a combination thereof.

26. The article of claim 25, wherein the food item is disposed within the flexible food packaging laminate.

27. The article of claim 25, wherein said laminate is free of contaminants selected from the group consisting of isocyanates, aromatic amines and mixtures thereof.

28. The article of claim 25 further comprising a container, a cap, and a cap seal, said cap seal comprising said flexible food packaging laminate.

29. The article of claim 25, wherein said food item is selected from the group consisting of medicine, snack foods, confectionery, aqueous foods, moist foods, dry food stuffs, milk, coffee, tea, cheese, fresh fruits, fresh vegetables, fresh meats, fish and combinations thereof.

30. The article of claim 25, wherein a first surface of said flexible food packaging laminate is heat sealed to a second surface of said flexible food packaging laminate.

31. The article of claim 25, wherein said food item is vacuum packaged.
